(19) United States
(12) Patent Application Publication
(10) Pub. No.: US 2010/0285750 A1
(43) Pub. Date: Nov. 11, 2010

(54) Wireless Audio Stereo and Intercom System

(76) Inventor: Chris Simonelic, Tempe, AZ (US)

Correspondence Address: Chris Simonelic, 2640 W Medtronic Way, Tempe, AZ, 85281, US

(21) Appl. No.: 12/773,806

(22) Filed: May 4, 2010

Related U.S. Application Data
(60) Provisional application No. 61/213,095, filed on May 6, 2009.

(51) Int. Cl. H04B 7/00; H04R 5/00

(52) U.S. Cl. 455/41.3; 381/1

(57) ABSTRACT

This invention extends standard Bluetooth wireless audio features and capabilities to provide full wireless stereo headset capabilities, and maintain backward compatibility with standard Bluetooth devices. This invention is a full duplex, high fidelity, low latency, two-way digital wireless audio headset with microphone intercom communication system that deploys custom programmed Bluetooth radio transceiver devices.

### CROSS-REFERENCE TO RELATED APPLICATION

This application claims the benefit of the filing date of U.S. Provisional Patent Application No. 61/213,095 which was filed May 5, 2009.

### BACKGROUND

The recent history and current availability of portable digital wireless audio systems represents a series of compromises due to cost constraints, hardware capabilities, firmware availability, power requirements, and radio frequency bandwidth limitations. Digital wireless audio systems are presently still unable to fully duplicate the quality and capabilities of traditional wired systems, as they are currently compromised in one or more of these aspects.

Bluetooth is a very popular wireless system, and Bluetooth specifications define two major types of usage profiles: audio and data. Two audio profiles commonly exist that provide interoperability specifications for actual audio communication: Advanced Audio Distribution Profile (A2DP) and Headset/Hands Free Profile (HSP/HFP). Bluetooth HSP/HFP is the most popular profile which provides low fidelity bi-directional monaural audio channels, suitable for a two-way audio communication link to a mobile phone. The resultant low quality audio is undesirable for listening to music or for use with voice recognition applications. Bluetooth A2DP provides unidirectional high fidelity wireless audio in stereo, but has no provision for two-way audio communications. Furthermore, while the HSP/HFP has a minimal audio delay, standard A2DP typically has a significant algorithmic delay for its wireless steaming audio signal.

It is not uncommon where both of these Bluetooth profiles have been deployed together in a single headset product, providing two distinct solutions in different operational modes, such as wirelessly listening to music, and alternatively accepting an incoming cell phone call using the same wireless headset. However, switching between two distinct solutions does not provide the seamless all-in-one solution of simultaneous high fidelity stereo with intercom communications.

Generic digital wireless audio communications systems have been recently developed utilizing the same 2.4 GHz radio frequency band as Bluetooth. However, non-Bluetooth systems do not typically offer the efficient bandwidth utilization of Bluetooth and other advantages of Bluetooth such as low cost, low power consumption, wide choice of hardware chips, and definitely do not offer compatibility with the enormous range of Bluetooth enabled consumer audio devices including digital music players, computers, cell phones, and multimedia smart phone devices.

A wireless version of a full stereo headset is desired. The requirements demand a low latency, high fidelity, digital wireless audio two-way communication system using cost effective hardware and firmware that most closely approximates the performance capabilities of a standard wired stereo headset. Additionally, compatibility with other popular wireless audio devices would be more compelling, useful, and valuable.

### SUMMARY

The present invention is directed to portable wireless audio communication systems. While wireless stereo using the Bluetooth A2DP profile and wireless two-way communications using the Bluetooth HSP/HFP profile are individually very capable, and widely used, there are a number of applications where the best combined qualities and capabilities of both of these types of systems is desired, but not previously available.

Some applications for this wireless stereo and intercom communication system include airplanes, race cars, helicopters, snow mobiles, boats, motorcycles, and other high noise and hostile environments where the user wears a protective helmet or headset due to loud ambient noise, and desires a combined high fidelity stereo and intercom wireless audio system integrated into the helmet or headset. Other applications where this combined wireless audio stereo and intercom system is useful include video gaming, interactive multimedia learning, and training simulators, where the user desires a stereo headset to privately listen to high fidelity stereo audio, but also desires intercom capability for live communications or voice recognition control.

Furthermore, the low latency wireless feature is also desired in many of these stereo and intercom applications in order to more closely approximate the performance of existing wired headset systems. The low latency feature is desired for audio visual synchronization, and in other applications, because the two-way communications is more natural with a minimal audio delay.

The present invention utilizes multiple Bluetooth audio devices, which are modified to provide the specified capabilities and performance. By programming a new upper layer profile, and modifying, configuring, and creating several other sections of an otherwise Bluetooth compliant system, the required capabilities and performance of the invention can be realized. These and other features, aspects, and advantages of the present invention will become better understood with reference to the following description and claims.

### BRIEF DESCRIPTION OF THE DRAWINGS

FIG. 1 illustrates an exploded system view of a wireless audio stereo and intercom system in one example of the invention.

FIG. 2 illustrates wireless connectivity features between said first transceiver of the invention and a number of different types of wireless devices.

FIG. 3 illustrates wireless connectivity features between said second transceiver of the invention and a number of different types of wireless devices.

### DETAILED DESCRIPTION OF SPECIFIC EMBODIMENTS

Methods and apparatuses for digital wireless audio stereo with microphone intercom systems are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

A preferred embodiment is a wireless gaming stereo headset with microphone coupled with a wireless USB transceiver dongle. This wireless audio stereo and intercom system embodiment is intended to directly substitute a traditional wired connection between a stereo headset with microphone and a personal computer, and due to several of the features in this invention, maintain suitability for video gaming and other interactive multimedia requirements. The invention also provides additional connectivity features unavailable from a traditional wired headset stereo and intercom system.

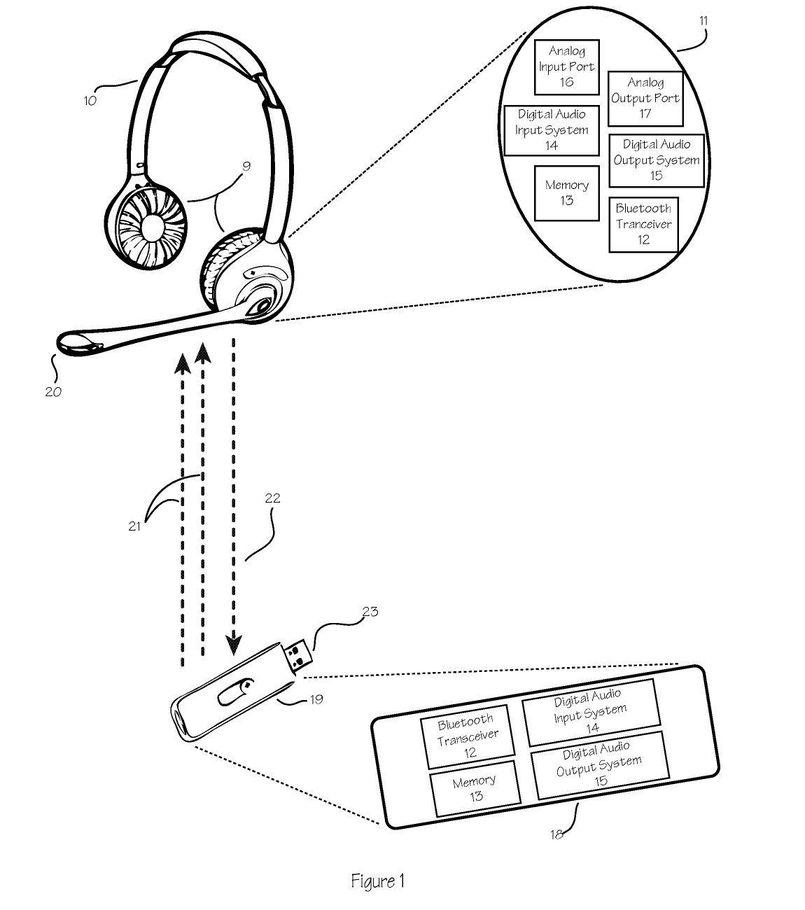

Referring to FIG. 1, a stereo headset 10 contains a digital wireless audio transceiver device 11. The headset transceiver device 11 comprises a Bluetooth transceiver 12, a memory module 13 which contains Bluetooth firmware and profiles code, an analog input port 16 connected to an analog to digital audio encoder, a digital audio input system 14, an analog output port 17 connected to a digital to analog audio encoder, and a digital audio output system 15. In this embodiment, the analog to digital encoder, and the digital to analog encoder are integrated hardware features contained within in the Bluetooth transceiver 12. The analog audio input port 16 is connected to a microphone 20 in customary wired fashion, and the analog audio output port 17 is connected to a pair of stereo speakers 9 also in customary wired fashion.

The Bluetooth transceiver 12 is concurrently transmitting a monaural voice audio signal 22 while receiving a high fidelity stereo signal 21. The microphone 20 provides the monaural voice audio signal to the analog input port 16, is digitized by an analog to digital encoder, sent to the digital audio input system 14, processed by the firmware program provided in the memory 13, and transmitted wirelessly by the Bluetooth transceiver 12. Simultaneously, the Bluetooth transceiver is wirelessly receiving a high fidelity stereo signal 21, processing the signal with the firmware program in memory 13, outputted to the digital audio output system, processed by the digital to analog encoder, sent to the analog output port 17 which is connected to the stereo speakers 9.

This invention broadly claims such a headset transceiver device 11 based on the scope and spirit of this communication system as encompassing other embodiments such as helmets, hats, visors, pendants, back packs, vehicle audio systems, portable audio devices, incorporated into home automation system devices, built into televisions and video monitors, incorporated into recording studio systems, implemented within a general purpose computer system, or even external transceiver devices that would provide the wireless audio stereo and intercom system capabilities to stand alone audio components.

Also referring to FIG. 1, a USB wireless dongle 19 contains a digital wireless audio transceiver device 18. This base unit transceiver device 18 contains a Bluetooth transceiver 12 and a memory module 13 which contains Bluetooth firmware and profiles code, a digital audio input system 14, and a digital audio output system 15. In this embodiment, the digital input and output systems are physically connected to a laptop computer using a common USB digital audio interface 23. In this embodiment for use with a video game application, the game audio signal is routed via USB audio interface 23 to the base transceiver device 18 inside the USB wireless dongle 19 which is wirelessly transmitted 21 to the headset transceiver device 11. Additionally, any transmitted monaural voice audio signal 22 from the headset 10 microphone 20 is received by the base transceiver device 18 contained in the USB wireless dongle 19, and provided to the video game application in the same fashion as a standard wired stereo headset with intercom that utilizes a USB connector 23.

This invention broadly claims such a base transceiver device 18 based on the scope and spirit of this communication system as encompassing other embodiments such as integration within a larger radio system, implemented within a general purpose computer system, built into a video game console, built into televisions and video monitors, incorporated into a home automation system device, added to musical instruments, or even external transceiver devices that would provide the wireless audio stereo and intercom system capabilities to stand alone audio devices.

Standard Bluetooth firmware in both the headset transceiver device 11 and the base transceiver device 18 is improved in several aspects in order to implement the specifications of this invention. Firstly, the high fidelity stereo signal 21 improves a typical Bluetooth A2DP implementation. It differs by replacing the standard Bluetooth specified Sub Band Coding (SBC) algorithm with a low latency audio compression algorithm. SBC uses a Fast Fourier Transfer type algorithm that adds significant processing delay because of the necessary look ahead and look back audio buffers. At least a few low latency audio compression algorithms are available that can be utilized to provide the not only the low latency feature, but also the high fidelity quality feature, and can sufficiently provide the necessary compression levels required by the wireless bandwidth constraints of a Bluetooth system. Some of the challenges of using a low latency audio algorithm are the lack of time available to allow for retransmissions of corrupt audio data packets, the lack of sufficient compression levels, the difficulty of retaining high fidelity sonic quality, and possibly increased hardware processor requirements with the consequential increased power demand. Of course, the necessity of low latency compression algorithms is only utilized as a compromised solution to bandwidth limitations. One skilled in the art can implement the desired and specified low latency algorithm either internally to the transceiver devices in firmware contained in the memory 13, or by use of other software or firmware operating on additional supporting external hardware devices.

It is broadly claimed that any suitable low latency compression scheme can be deployed in this invention, including no compression. The low latency feature is vital to providing a synchronized audio video solution for the interactive multimedia applications, and for providing high performance two-way, non-visual applications for the purpose of improved performance more closely approximating wired systems.

Secondly, another Bluetooth firmware improvement involves the provisioning of the concurrent monaural voice audio signal 22 transmitting from the headset transceiver device 11 to the base transceiver device 18, while receiving high fidelity stereo signal 21 from the base transceiver device 18. While standard Bluetooth A2DP provides for a unidirectional high fidelity stereo signal 21 from the base transceiver 18, to the headset transceiver 11, a second, reverse direction monaural voice audio signal 22 is not provided or specified. A person sufficiently skilled in Bluetooth programming and profile development will have the skills to create a custom upper layer profile utilizing the similar high fidelity capabilities and configuration as A2DP, that properly configures the underlying Bluetooth lower link layers to create, provide, and utilize bi-directional, asymmetrical wireless audio links for the specified high fidelity stereo signal 16 and monaural voice audio signal 22 within the base transceiver device 18, and the complimentary bi-directional, asymmetrical wireless links for the monaural voice audio signal 17 transmission along with the high fidelity stereo signal 21 reception within the headset transceiver device 11.

Thirdly, a further Bluetooth firmware improvement involves the recognition, configuration, and proper handling of the specified standard and non-standard Bluetooth audio profiles, including the custom stereo and intercom profile, standard A2DP, and standard HSP/HFP, in order to provide the Bluetooth backward connectivity features specified in this invention. Bluetooth has general structural provisions for the existence and usage of new, improved, or extended upper layer profiles, and a person expertly skilled in Bluetooth profile development and programming will be able to make the necessary adaptations and improvements.

As previously mentioned in brief, backward connectivity and compliance with Bluetooth standard profiles adds significant value and utility to this invention. Because Bluetooth is one of the most common and widely used wireless audio systems, the capability to connect with a vast array of consumer electronic audio devices is a compelling and useful proposition that helps justify the possible additional costs of a high end stereo and intercom system. Furthermore, without this backward connectivity, this stereo and intercom device would not be considered Bluetooth complaint, and could not enjoy the benefits and rights conferred by the Bluetooth Special Interest Group of marketing this product as a Bluetooth product.

This invention is intended to broadly claim backward Bluetooth compatibility for the benefits previously specified. As such, any incremental improvements, capabilities, or additions by Bluetooth to its related standard wireless audio profiles should be considered obvious extensions of this invention.

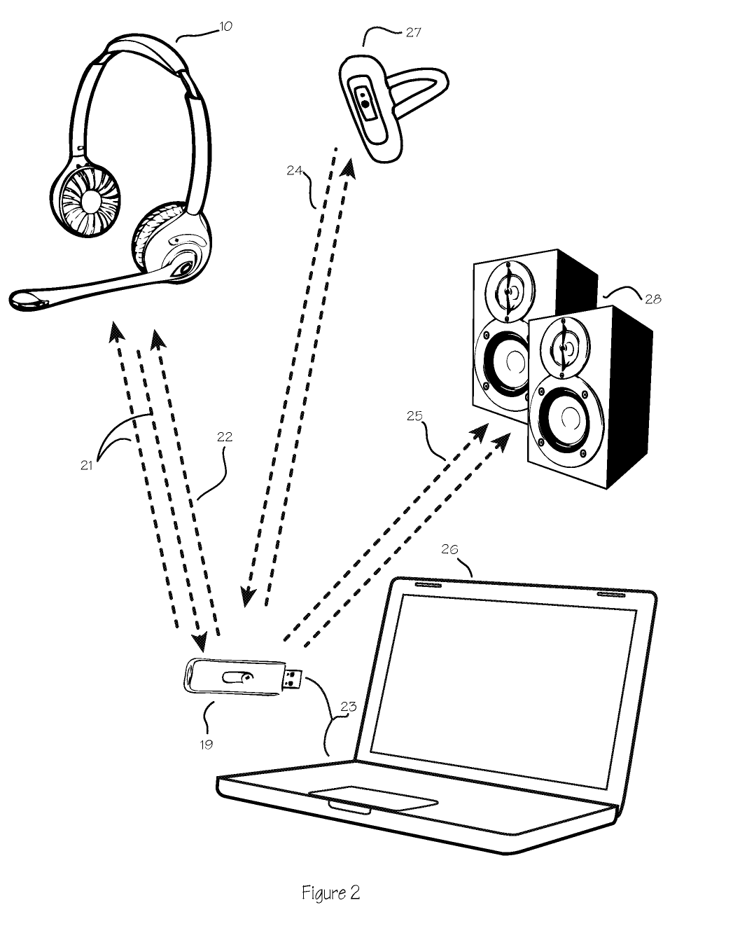

Referring to FIG. 2, in this embodiment, a base transceiver device embodied as a USB wireless dongle 19. It is connected to a computer 26 using a standard USB interface 23. The audio communication between the computer 26 and the USB wireless dongle 19 is digital only. The USB wireless dongle 19 is wirelessly connectable to any Bluetooth enabled device that has the common Bluetooth audio profiles, A2DP and HSP. For example, the USB wireless dongle 19 is wirelessly connectable to a Bluetooth enabled mobile phone headset 27 that has the Bluetooth HSP profile. When wirelessly connected to a mobile phone headset 27, the USB wireless dongle 19 only uses a limited bi-directional low fidelity audio signal 24 which is fully enabled and compliant to the Bluetooth standard specification for HSP. The USB wireless dongle 19 is also wirelessly connectable to Bluetooth enabled speakers 28 that have the Bluetooth A2DP sink profile. When wirelessly connected to speakers 28, the USB wireless dongle 19 only uses a limited unidirectional high fidelity stereo audio signal 25 which is fully enabled and compliant to the Bluetooth standard specification for A2DP. And of course, the USB wireless dongle 19 is wirelessly connectable to a headset 10 containing a headset transceiver device of this invention. When wirelessly connected to the headset 10, the full bi-directional, low latency, high fidelity stereo audio signal 21 and monaural voice audio signal 22 features are recognized and enabled by each transceiver.

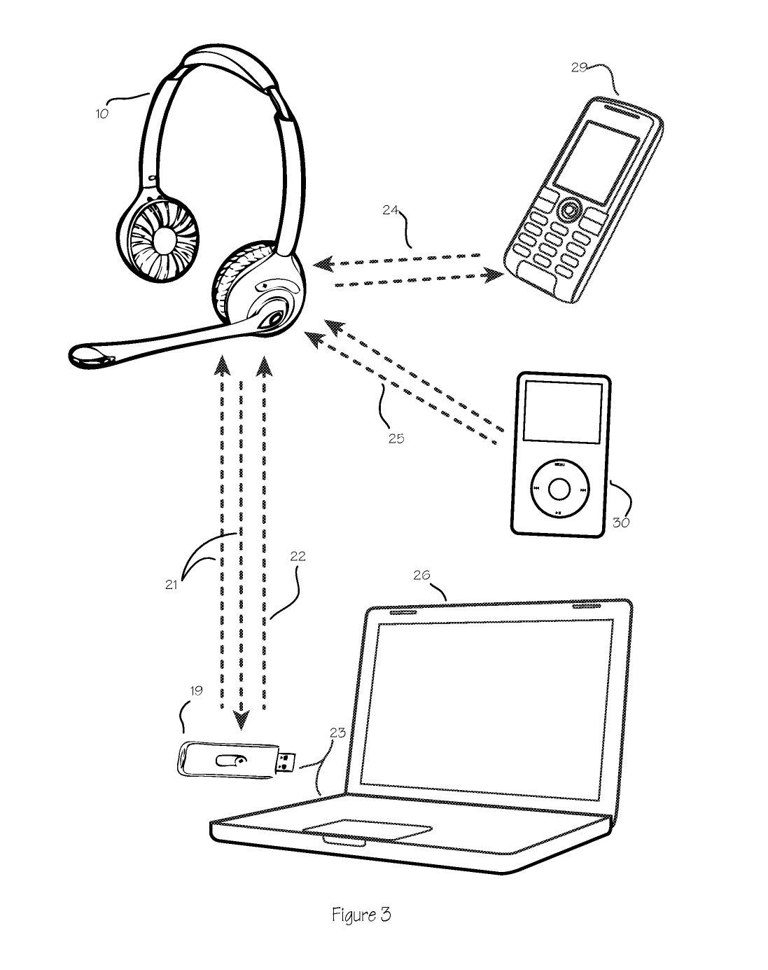

Referring to FIG. 3, in this embodiment, a headset transceiver device is embodied as headset 10. The headset 10 is wirelessly connectable to any Bluetooth enabled device using any of the common Bluetooth audio profiles, including A2DP and HSP. For example, the headset 10 is wirelessly connectable to a Bluetooth enabled mobile phone 29 that has the Bluetooth Audio Gateway HSP profile. When wirelessly connected to a mobile phone 29, the headset 10 uses a limited bi-directional, low fidelity audio link which is fully enabled and compliant to the Bluetooth standard specification for HSP. The headset 10 is also wirelessly connectable to a Bluetooth enabled music player device 30 that has the Bluetooth A2DP source profile. When wirelessly connected to a music player device 30, the headset 10 uses a limited unidirectional high fidelity stereo link which is fully enabled and compliant to the Bluetooth standard specification for A2DP. And of course, the headset 10 is wirelessly connectable to a base transceiver embodied as a USB wireless dongle 19. When wirelessly connected to a USB wireless dongle 19, the full bi-directional, low latency, high fidelity stereo audio signal 21 and monaural voice audio signal 22 are recognized and enabled by each transceiver.

Additionally, the headset 10 can wirelessly connect to a mobile phone 29 and either a music player device 30 or a USB wireless dongle 19. When the headset 10 is wirelessly connected to two devices, one of the two devices is put into standby mode without an active audio transmission or reception, while the other device is actively operating a full wireless audio link according to the specification. This secondary, standby mode link to a mobile phone 29 provides a great convenience that allows immediate use of the mobile phone without the need to drop one wireless connection and enable another in order accept a phone call. Furthermore, when the mobile phone 29 is in standby mode, and receiving an incoming call, an audible ring tone is generated in the headset 10 to provide notification of the call. At this point, the wearer can accept or reject the call from the mobile phone 29 with a button press scheme.

This convenient, novel, and valuable mobile phone connectivity feature is very desirable in many of the helmet embodiments that will utilize this audio communication system. Even within more causal applications, users will find the added usefulness compelling. This additional mobile phone connectivity is one feature that surpasses the capabilities of the standard wired stereo headsets it is intending to replace.

Another preferred embodiment is a wireless audio stereo and intercom system, functionally similar to the previous embodiment, but where the headset transceiver device is a stereo headset, and the base transceiver device is integrated into a video game console system.

Another preferred embodiment is a wireless audio stereo and intercom system, functionally similar to the previous embodiment, where the headset transceiver device is contained within a protective helmet. The base transceiver device can be attached or otherwise integrated into the vehicle radio communication system. This wireless audio stereo and intercom system embodiment is intended to provide a full featured wireless entertainment and two-way audio communications system for in-vehicle use such as airplanes, race cars, helicopters, snow mobiles, boats, motorcycles, and other high noise and hostile environments.

This invention is intended to broadly claim high fidelity stereo audio signal 21 to include incremental and obvious high fidelity audio improvements such as a low frequency subwoofer channels, quadraphonic audio, 5.1 surround sound audio, 7.1 surround sound audio, and other sonic improvements and technologies such as equalization, noise cancellation, or Dolby features that are offered in other wired and wireless high fidelity headphones and headsets. High fidelity is also broadly claimed to include possible reductions in some sonic qualities as a bandwidth compromise in order to provide other application specific features such as providing additional bandwidth error correction schemes, channel redundancy, multiple audio channel solutions, or even multiple headset systems. Some of these features may compromise sonic quality of one feature in order to provide another, with the overall solution still considered high fidelity in general.

Similarly, the microphone intercom audio signal 22 is intended to be broadly claimed as high fidelity audio that could include incremental and obvious audio improvement features such utilizing additional microphone audio channels for noise cancellation, whether provided at the first transceiver, or the second transceiver. The high fidelity monaural voice signal is specified in order to provide advanced, voice recognition capabilities, and to more closely approximate the monaural voice signal quality of wired stereo headset intercom systems.

1. A wireless communication system comprising: a first Bluetooth transceiver device comprising a memory module that stores a plurality of operational instructions for implementing a plurality of protocols and layers of Bluetooth, a digital audio input system, and a digital audio output system, whereby said first transceiver is concurrently capable of wirelessly transmitting an audio signal comprising at least two audio channels and receiving an audio signal comprising at least one audio channel; a second Bluetooth transceiver device comprising a memory module that stores a plurality of operational instructions for implementing a plurality of protocols and layers of Bluetooth, a digital audio input system, and a digital audio output system, whereby said second transceiver is concurrently capable of wirelessly receiving an audio signal comprising at least two audio channels and transmitting an audio signal comprising at least one audio channel.

2. The communication system of claim 1, whereas said first transceiver is capable of concurrently transmitting a high fidelity stereo signal and receiving a high fidelity monaural voice signal.

3. The communication system of claim 1, whereas said second transceiver is capable of concurrently transmitting a high fidelity monaural voice signal and receiving a high fidelity stereo signal.

4. The communication system of claim 1, whereas the wireless audio transmitting and receiving between said first transceiver and said second transceiver uses rapid time-division multiplexing that provides a full duplex audio connection.

5. The communication system of claim 1, whereas the wireless audio transmitting and receiving between said first transceiver and said second transceiver uses a single Bluetooth profile connection.

6. The communication system of claim 1, whereas said first transceiver is wirelessly connectable to a Bluetooth A2DP (Advanced Audio Distribution Profile) sink device.

7. The communication system of claim 1, whereas said first transceiver is wirelessly connectable to a Bluetooth HSP/HFP (Headset/Hands Free Profile) device.

8. The communication system of claim 1, whereas said second transceiver is wirelessly connectable to a Bluetooth A2DP (Advanced Audio Distribution Profile) source device.

9. The communication system of claim 1, whereas said second transceiver is wirelessly connectable to a Bluetooth AGHSP/AGHFP (Audio Gateway Headset/Hands Free Profile) device.

10. The communication system of claim 1, whereas said second transceiver can be simultaneously connected wirelessly to both a Bluetooth AGHSP/AGHFP device, and connected wirelessly to either a said first transceiver or a Bluetooth A2DP source device.

11. The communication system of claim 1, whereas said second transceiver when connected wirelessly to said first transceiver, is capable of receiving said audio signals from said first transceiver with less than an 80 millisecond delay.

12. The communication system of claim 1, whereby said first transceiver further comprises an analog to digital encoder, and a digital to analog encoder.

13. The communication system of claim 1, whereby said second transceiver further comprises an analog to digital encoder, and a digital to analog encoder.

14. The said first transceiver of claim 1 is a USB audio device.

15. The said second transceiver of claim 13 is a stereo headset with microphone.

16. The communication system of claim 1, further comprises a third transceiver device comprising: a memory module that stores a plurality of operational instructions for implementing a plurality of protocols and layers of Bluetooth, a digital audio input system, and a digital audio output system, whereby said third transceiver is concurrently capable of wirelessly receiving at least two audio signals and transmitting at least one audio signal.
